(19) United States
(12) Patent Application Publication
(10) Pub. No.: US 2006/0165306 A1
(43) Pub. Date: Jul. 27, 2006

(54) Method and apparatus for encoding and decoding three-dimensional mesh information

(76) Inventors: Euee-S Jang, Seoul (KR); Dae-Ha Ryu, Seoul (KR); Dai-Yong Kim, Buk-gu (KR); Mi-Ja Kim, Seoul (KR); Sung-Won Park, Seoul (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/331,541

(22) Filed: Jan. 13, 2006

Related U.S. Application Data
(63) Continuation of application No. PCT/KR04/01730, filed on Jul. 13, 2004.

(30) Foreign Application Priority Data
Jul. 16, 2003 (KR) 10-2003-0048509
Jan. 28, 2004 (KR) 10-2004-0005474

(51) Int. Cl. G06K 9/46

(52) U.S. Cl. 382/243

(57) ABSTRACT

A method and apparatus for encoding and decoding three dimensional (3D) mesh information, especially, for outputting data in a decoding process with the number of digits of original data are disclosed. One embodiment of the present invention comprises 3DMC mesh data encoding at a transmitting end for counting the number of digits of original data and generating a 3DMC packet including an encoded original data and the digit number, transmitting the 3DMC packet to a receiving end, and 3DMC mesh data decoding at the receiving end for reconstructing and outputting the encoded original data based on the number of digits. According to one embodiment of the invention, the fidelity of data reconstruction is increased.

### RELATED APPLICATIONS

This application is a continuation application, and claims the benefit under 35 U.S.C. §§ 120 and 365 of PCT Application No. PCT/KR2004/001730, filed on Jul. 13, 2004 and published on Jan. 27, 2005, in English, which is hereby incorporated by reference.

### BACKGROUND OF THE INVENTION

1. Technical Field of the Invention

The present invention relates to a method and apparatus for encoding and decoding three dimensional (3D) mesh information, especially, for outputting data in a decoding process with the number of digits of coordinates of original data so as to increase the fidelity of data reconstruction.

2. Description of the Related Technology

Although 3D graphics have been used more frequently these days, it has not been widely used due to a huge amount of data to be processed. For example, presenting 3D mesh data requires geometrical data of each pixel, link data between each pixel, and attribute data such as color, normal and texture coordinates.

Accordingly, there was a need for encoding the great deal amount of data. For this, 3D mesh coding (3DMC) device adopted as a standard of ISO/IEC (International Organization for Standardization/International Electrotechnical Commission) in MPEG-4 (Moving Picture Expert Group)-SNHC (Synthetic and natural hybrid coding (SNHC) increases the transmission efficiency of 3D mesh data represented as indexedfaceset (IFS).

But, the conventional encoding and decoding technique using 3DMC has some defects such as an imperfect reconstruction of original data and data loss.

Also, because of the data loss, it can be unacceptable in medical applications or engineering applications such as CAD, both requiring relatively high fidelity.

Hereinafter, the defects of the conventional technique will be described. FIG. 1 shows the encoding process of 3DMC according to the conventional technique, and FIG. 2 shows the changes of IFS data after encoding and decoding process of 3DMC according to the conventional technique.

Referring to FIG. 1, IFS data after quantization is encoded and transmitted in the form of a 3DMC bit stream.

The bit stream generated through aforementioned encoding process is reconstructed in the decoding process. FIG. 2 shows IFS coordinates values 210 of original data and IFS coordinates values 220 after encoding and decoding process using 3DMC.

The encoding and decoding technique using the conventional device can increase compression ratio and transmission efficiency. But, the encoding and decoding technique using the conventional 3DMC device cannot exactly restore original data, thus causing data loss. This may result from data loss in the quantization process and decoding process due to the output format of data.

The data format of the conventional 3DMC decoding process is 8.4f, i.e., total 8 digits including decimal point and down to 4 digits.

For example, in the case of two original data 0.00001111 and 0.00009999, according to the conventional 3DMC, both are displayed as 0.0000.

Because of this result, conventional 3DMC encoding and decoding technique cannot be applied to the medical applications or engineering applications such as CAD.

FIG. 3 is a fidelity graph when bites per vertex (BPV) changes in the conventional 3DMC encoding and decoding technique.

The conventional 3DMC encoding and decoding technique can increase fidelity when reconstructing original data by increasing BPV, and the fidelity graph of reconstructed data as BPV change is shown in FIG. 3.

Although it should show no loss or near-no loss when BPV increases, the data graph of the conventional 3DMC encoding and decoding technique in FIG. 3 shows a constant root mean square (RMS) value after 18 bits.

That is, there is no difference between 18 bits and 30 bits in the conventional 3DMC encoding and decoding technique.

FIG. 4 shows pseudo colors representing the fidelity when BPV changes in the conventional 3DMC encoding and decoding technique.

In FIG. 4, pseudo colors represent the fidelity between the original file and the output file, which was encoded and decoded according to the BPV. And, it can be determined that the more there exists one particular color (e.g., red), the less the fidelity; the more different colors (e.g., blue), the higher the fidelity.

As shown in FIG. 4, although BPV is designated by 10 (410), 15 (420), 20 (430) and 25 (440), respectively, the fidelities are not different from each other.

Although the conventional 3DMC encoding and decoding technique provides high compression ratio of 30-50:1, there is not much consideration in the view of near-no-loss fidelity.

Accordingly, since medical applications or engineering applications need the fidelity of data rather than compression ratio, the conventional 3DMC encoding and decoding technique cannot be applicable to these applications.

### SUMMARY OF CERTAIN INVENTIVE ASPECTS

One aspect of the present invention provides a method and device for encoding and decoding 3D mesh data, which can increase the fidelity of reconstructed data by outputting data in consideration of digits of original data during the decoding process.

Another aspect of the present invention provides a method and device for encoding and decoding 3D mesh data applicable to medical applications or engineering applications, both requiring fidelity of data rather than a high compression ratio.

Another aspect of the present invention provides a method of encoding and decoding 3D mesh data, comprising: i) 3DMC mesh data encoding at a transmitting end for counting a digit of coordinates of original data and generating a 3DMC packet including an encoded original data and the digit, ii) transmitting the 3DMC packet to a receiving end, and iii) 3DMC mesh data decoding at the receiving end for reconstructing and outputting the encoded original data based on the digit. Another aspect of the present invention provides a system, a device and recording medium for encoding and decoding the 3D mesh data.

In one embodiment, the method of encoding and decoding 3D mesh data comprises (a) encoding an original data, (b) counting the number of a digit of coordinates of the original data in said (a), and (c) generating a 3DMC packet including the encoded original data and the digit number.

In one embodiment, the method of decoding 3D mesh data comprises receiving a 3DMC packet from a receiving end, examining whether the 3DMC packet includes the number of a digit in a predetermined field, extracting the digit number in the case that the digit number exists, and reconstructing and outputting the original data by use of the extracted digit number.

In one embodiment of the present invention, the digit number is included in the header of 3DMC packet by use of a predetermined syntax.

### BRIEF DESCRIPTION OF THE DRAWINGS

FIG. 1 shows the encoding process of 3DMC according to the conventional technique;

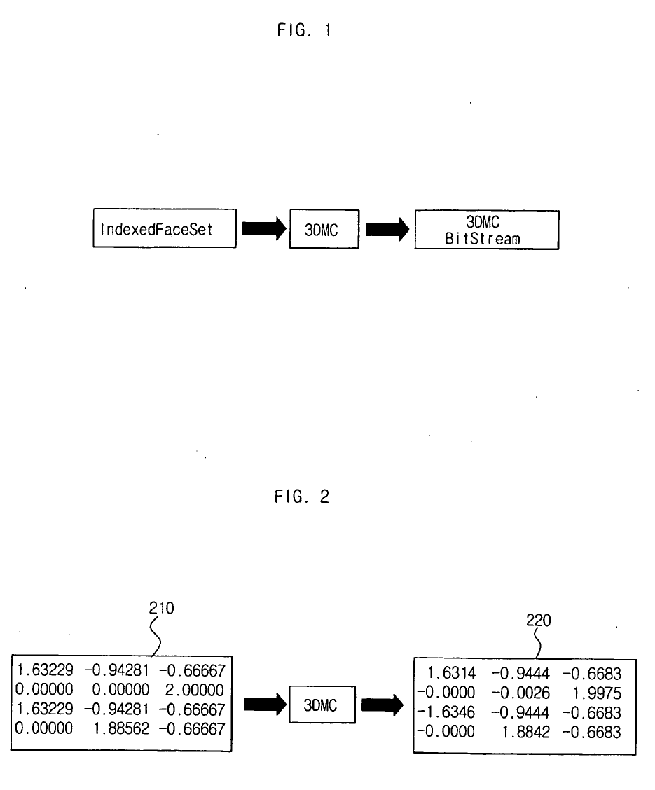

FIG. 2 shows the changes of IFS data after the encoding and decoding process of 3DMC according to the conventional technique;

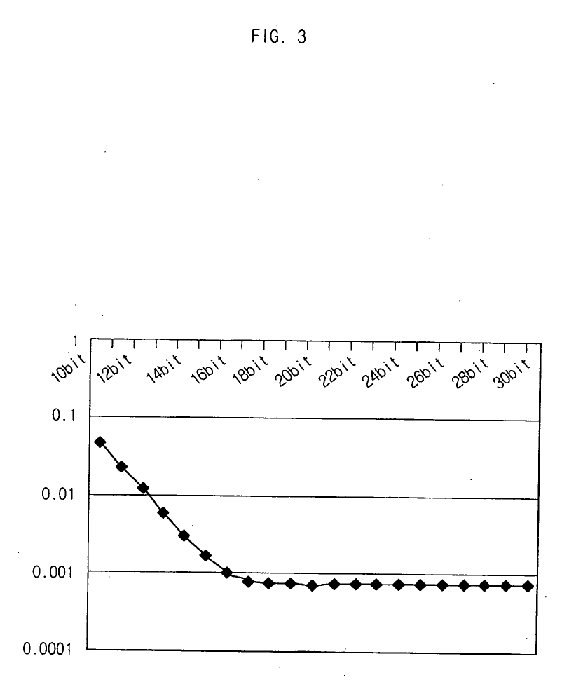

FIG. 3 is a fidelity graph when BPV changes in the conventional 3DMC encoding and decoding technique;

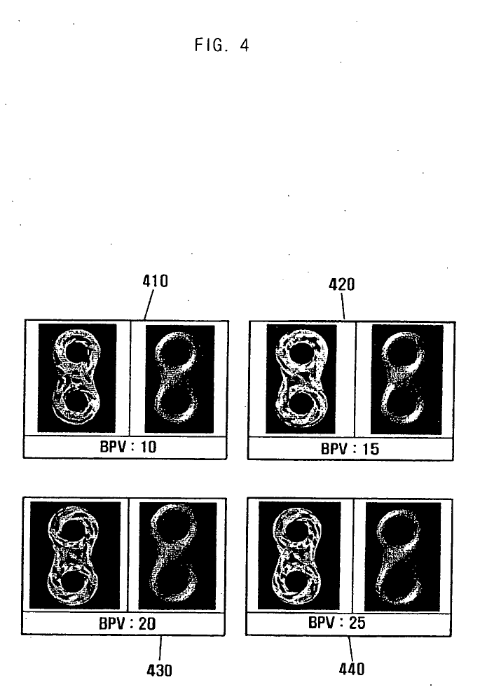

FIG. 4 shows pseudo colors representing the fidelity when BPV changes in the conventional 3DMC encoding and decoding technique;

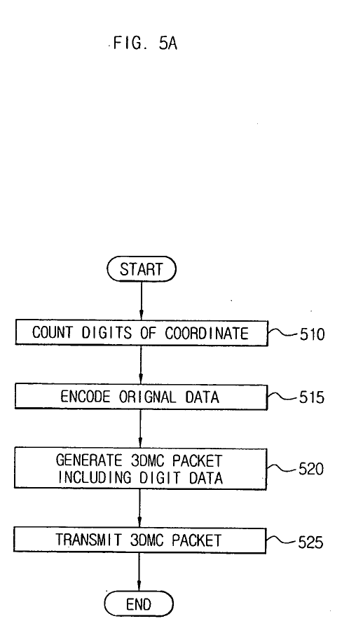

FIG. 5 is a flowchart of the 3DMC encoding process for increasing the fidelity of reconstructed data according to one embodiment of the invention;

FIG. 6 is a flowchart of the 3DMC decoding process for increasing the fidelity of reconstructed data according to one embodiment of the invention;

FIGS. 7 and 8 are graphs for comparing the fidelity in the conventional technique and one embodiment of the present invention when BPV changes.

### DETAILED DESCRIPTION OF CERTAIN INVENTIVE EMBODIMENTS

Hereinafter, the method and device for encoding and decoding 3D mesh data according to embodiments of the present invention will be described with accompanying drawings. Since 3DMC encoding and decoding technique is well-known in the art, detailed description about 3DMC will be omitted here. In describing with accompanying drawings, identical reference numbers will be used to same or corresponding elements and description about same elements will be omitted.

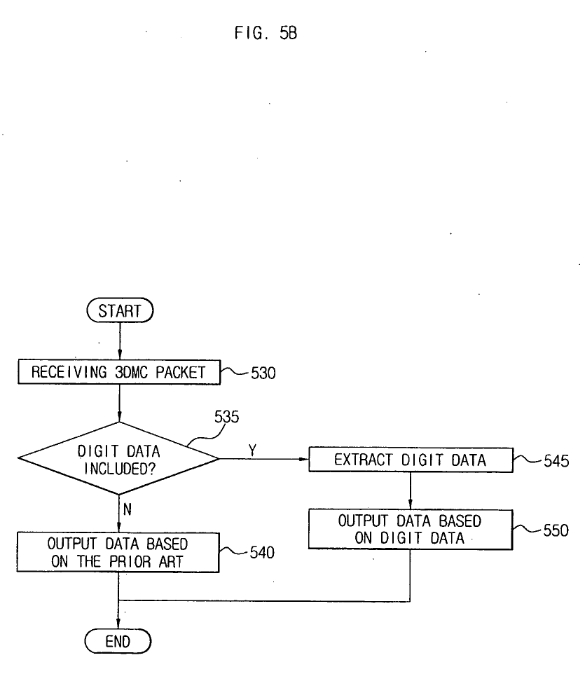

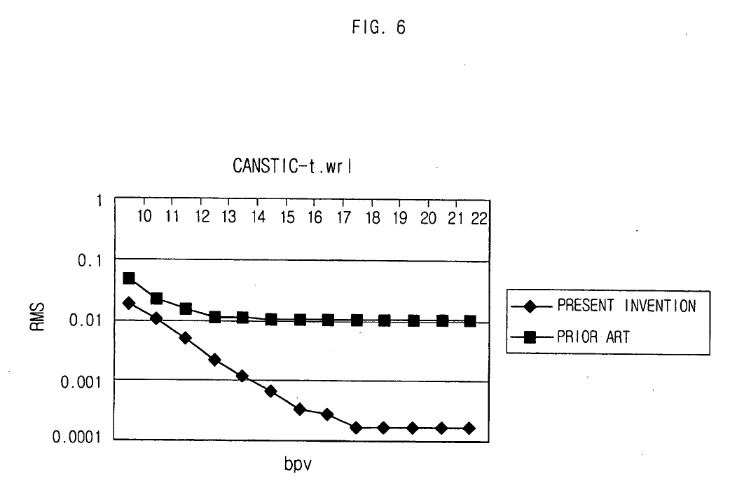

FIG. 5 is a flowchart of the 3DMC encoding process for increasing the fidelity of reconstructed data, and FIG. 6 is a flowchart of 3DMC decoding process for increasing the fidelity of reconstructed data.

For the convenience of understanding, processes of FIGS. 5 and 6 will be described as these were performed successively.

Referring to FIG. 5, during encoding 3D mesh data, 3DMC device counts the digit of coordinates of original data at step 510, and then encodes original data at step 515.

The 3DMC device generates 3DMC packet including digit data in the predetermined field (e.g., data field) at step 520, and then transmits the 3DMC packet at step 525.

The generated 3DMC packet comprises a header and payload. For example, the digit data can be inserted into the header and then transmitted.

Table 1 to 5 show syntaxes included in the bit stream structure that were regulated in ISO/IEC 14496-2.

TABLE 1
3D_Mesh_Object_Header

| 3D_Mesh_Object_Header( ) { | No. of bits | Mnemonic |
|---|---|---|
| Ccw | 1 | bslbf |
| Convex | 1 | bslbf |
| Solid | 1 | bslbf |
| creaseAngle | 6 | uimsbf |
| coord_header( ) | | |
| normal_header( ) | | |
| color_header( ) | | |
| texCoord_header( ) | | |
| Ce_SNHC | 1 | bslbf |
| if(ce_SNHC==‘1’) | | |
| ce_SNHC_header( ) | | |
| } | | |

TABLE 2
coord_header

| | No. | |
|---|---|---|
| | of | |
| coord_header( ) { | bits | Mnemonic |
| coord_binding | 2 | uimsbf |
| coord_bbox | 1 | bslbf |
| if(coord_bbox==‘1’){ | | |
| coord_xmin | 32 | bslbf |
| coord_ymin | 32 | bslbf |
| coord_zmin | 32 | bslbf |
| coord_size | 32 | bslbf |
| } | | |
| coord_quant | 5 | uimsbf |
| coord_pred_type | 2 | uimsbf |
| if(coord_pred_type==‘tree_prediction”\|\| | | |
| coord_pred_type==‘parallelogram_prediction”) | | |
| coord_mlambda | 2 | uimsbf |
| for(i=1;i<coord_nlambda;i++) | | |
| coord_lambda | 4-27 | simsbf |
| } | | |
| } | | |

TABLE 3
normal_header

| normal_header( ) { | No. of bits | Mnemonic |
|---|---|---|
| normal_binding | 2 | uimsbf |
| if(normal_binding !=‘not bound”) | | |
| normal_bbox | 1 | bslbf |
| normal_quant | 5 | uimsbf |
| normal_pred_type | 2 | uimsbf |
| if(normal_pred_type==“tree_prediction”\|\| | | |
| normal_pred_type== | | |
| “parallelogram_prediction”){ | | |
| normal_nlambda | 2 | uimsbf |
| for(i=1;i<normal_nlambda;i++) | | |
| normal_lambda | 3-17 | simsbf |
| } | | |
| } | | |
| } | | |

TABLE 4
color_header

| color_header( ) { | No. of bits | Mnemonic |
|---|---|---|
| color_binding | 2 | uimsbf |
| if (color_binding != “not_bound”) { | | |
| color_bbox | 1 | bslbf |
| if (color_bbox == ‘1’) { | | |
| color_rmin | 32 | bslbf |
| color_gmin | 32 | bslbf |
| color_bmin | 32 | bslbf |
| color_size | 32 | bslbf |
| } | | |
| color_quant | 5 | uimsbf |
| color_pred_type | 2 | uimsbf |
| if (color_pred_type==“tree_prediction” \|\| | | |
| color_pred_type== | | |
| ‘“parallelogram_prediction”) { | | |
| color_nlambda | 2 | uimsbf |
| for (i=1; i<color_nlambda; i++) | | |
| color_lambda | 4-19 | simsbf |
| } | | |
| } | | |
| } | | |

TABLE 5
texCoord_header

| texCoord_header( ) { | No. of bits | Mnemonic |
|---|---|---|
| texCoord_binding | 2 | uimsbf |
| if (texCoord_binding != “not_bound”) { | | |
| texCoord_bbox | 1 | bslbf |
| if (texCoord_bbox == ‘1’) { | | |
| texCoord_umin | 32 | bslbf |
| texCoord_vmin | 32 | bslbf |
| texCoord_size | 32 | bslbf |
| } | | |
| texCoord_quant | 5 | uimsbf |
| texCoord_pred_type | 2 | uimsbf |
| if (texCoord_pred_type== | | |
| “tree_prediction” \|\| | | |
| texCoord_pred_type== | | |
| “parallelogram_prediction”) { | | |
| texCoord_nlambda | 2 | uimsbf |
| for (i=1; i<texCoord_nlambda; i++) | | |
| texCoord_lambda | 4-19 | simsbf |
| } | | |
| } | | |
| } | | |

But, as being described above, with syntaxes regulated in ISO/IEC 14496-2, it is impossible to perform the accurate data reconstruction which can be obtained in one embodiment of the present invention that uses digit data.

Thus, one embodiment of the present invention proposes new syntaxes for inserting digit data into header, and the new syntaxes are shown in Table 6 to 9.

TABLE 6
coord_header including new syntax

| coord_header( ) { | No. of bits | Mnemonic |
|---|---|---|
| coord_binding | 2 | uimsbf |
| coord_bbox | 1 | bslbf |
| if(coord_bbox==‘1’){ | | |
| coord_xmin | 32 | bslbf |
| coord_ymin | 32 | bslbf |
| coord_zmin | 32 | bslbf |
| coord_size | 32 | bslbf |
| } | | |
| coord_quant | 5 | uimsbf |
| coord_pred_type | 2 | uimsbf |
| if(coord_pred_type== | | |
| ‘tree_prediction”\|\| | | |
| coord_pred_type== | | |
| parallelogram_prediction”){ | | |
| coord_mlambda | 2 | uimsbf |
| for(i=1;i<coord_nlambda;i++) | | |
| coord_lambda | 4-27 | simsbf |
| } | | |
| HQ_coord_enable | 1 | uimsbf |
| if(HQ_coord_enable) { | | |
| coord_significant_figure_value | 5 | bslbf |
| } | | |
| } | | |

In Table 6, ‘HQ_coord_enable’ indicates that HQ (High Quality) mode (e.g., lossless mode or minimum loss mode) is set. In default mode, HQ mode may not be set.

And, ‘coord_significant_figure_value’ indicates an effective digit of vertex coordinates, and effective digit value 10’ is not used.

TABLE 7
normal_header including new syntax

| normal_header( ) { | No. of bits | Mnemonic |
|---|---|---|
| normal_binding | 2 | uimsbf |
| if(normal_binding !=‘not bound”) | | |
| normal_bbox | 1 | bslbf |
| normal_quant | 5 | uimsbf |
| normal_pred_type | 2 | uimsbf |
| if(normal_pred_type==“tree_prediction”\|\| | | |
| normal_pred_type== | | |
| “parallelogram_prediction”){ | | |
| normal_nlambda | 2 | uimsbf |
| for(i=1;i<normal_nlambda;i++) | | |
| normal_lambda | 3-17 | simsbf |
| } | | |
| } | | |
| HQ_normal_enable | 1 | uimsbf |
| if(HQ_normal_enable) { | | |
| normal_significant_figure_value | 5 | bslbf |
| } | | |
| } | | |

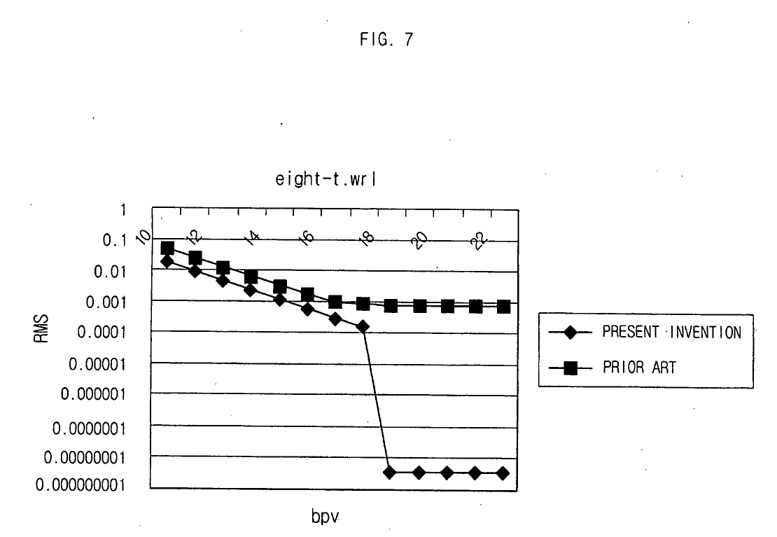

In FIG. 7, as already described above, ‘HQ_normal_enable’ is for indicating that HQ mode is set, and ‘normal_significant_figure_value’ is for indicating the effective digit value of vertex coordinates.

TABLE 8
color_header including new syntax

| color_header( ) { | No. of bits | Mnemonic |
|---|---|---|
| color_binding | 2 | uimsbf |
| if (color_binding != “not_bound”) { | | |
| color_bbox | 1 | bslbf |
| if (color_bbox == ‘1’) { | | |
| color_rmin | 32 | bslbf |
| color_gmin | 32 | bslbf |
| color_bmin | 32 | bslbf |
| color_size | 32 | bslbf |
| } | | |
| color_quant | 5 | uimsbf |
| color_pred_type | 2 | uimsbf |
| if (color_pred_type==“tree_prediction” \|\| | | |
| color_pred_type== | | |
| ‘“parallelogram_prediction”) { | | |
| color_nlambda | 2 | uimsbf |
| for (i=1; i<color_nlambda; i++) | | |
| color_lambda | 4-19 | simsbf |
| } | | |
| } | | |
| HQ_color_enable | 1 | uimsbf |
| if(HQ_color_enable) { | | |
| color_significant_figure_value | 5 | bslbf |
| } | | |
| } | | |

In FIG. 8, as already described above, ‘HQ_color_enable’ is for indicating that HQ mode is set, and ‘color_significant_figure_value’ is for indicating the effective digit value of vertex coordinates.

TABLE 9
texCoord_header including new syntax

| texCoord_header( ) { | No. of bits | Mnemonic |
|---|---|---|
| texCoord_binding | 2 | uimsbf |
| if (texCoord_binding != “not_bound”) { | | |
| texCoord_bbox | 1 | bslbf |
| if (texCoord_bbox == ‘1’) { | | |
| texCoord_umin | 32 | bslbf |
| texCoord_vmin | 32 | bslbf |
| texCoord_size | 32 | bslbf |
| } | | |
| texCoord_quant | 5 | uimsbf |
| texCoord_pred_type | 2 | uimsbf |
| if (texCoord_pred_type== | | |
| “tree_prediction” \|\| | | |
| texCoord_pred_type== | | |
| “parallelogram_prediction”) { | | |
| texCoord_nlambda | 2 | uimsbf |
| for (i=1; i<texCoord_nlambda; i++) | | |
| texCoord_lambda | 4-19 | simsbf |
| } | | |
| } | | |
| HQ_texCoord_enable | 1 | uimsbf |
| if(HQ_texCoord_enable) { | | |
| texCoord_significant_figure_value | 5 | bslbf |
| } | | |
| } | | |

In FIG. 9, as already described above, ‘HQ_texCoord_enable’ is for indicating that HQ mode is set, and ‘texCoord_significant_figure_value’ is for indicating the effective digit value of vertex coordinates.

Next, the decoding process of the 3DMC packet will be described.

The 3DMC device receives the 3DMC packet at step 530, and then determines whether or not digit data is included in the predetermined field (e.g., header) of the 3DCM packet.

If digit data is not included in the predetermined field, 3DMC device reconstructs and outputs corresponding data based on the corresponding decoding technique at step 540.

If digit data is included in the predetermined field, 3DMC device extracts digit data from the predetermined field at step 545.

Then, the 3DMC device reconstructs and outputs corresponding data with using digit data at step 550.

For example, if the coordinates of original data are 0.00001111, output data according to the conventional technique is 0.0000, but output data according to one embodiment of the present invention is 0.00001 I(when digit data is designated down to 6 digits), so it is possible to accurately reconstruct data compared to the conventional technique.

FIGS. 7 and 8 are graphs for comparing the fidelity in the conventional technique and one embodiment of the present invention when BPV changes.

As shown in FIGS. 7 and 8, it is apparent that insertion of digit data of original data into 3DMC packet data in the encoding process and reconstruction with digit data in the decoding process can provide more accurate result compared to the conventional technique.

Also, the difference of fidelity between each technique increases when BPV increases, and as a result, the fidelity of one embodiment of the present invention increases more and more when BPV increases.

As described above, the method and device for encoding and decoding 3D mesh data according to one embodiment of the present invention can increase the fidelity of reconstructed data by outputting data in consideration of the number of digits of original data during the decoding process.

Also, one embodiment of the present invention can be applied to medical applications or engineering applications, both requiring the fidelity of data rather than a high compression ratio.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

1. A method of encoding and decoding three dimensional (3D) mesh data, comprising:
encoding 3D mesh data at a transmitting end, wherein the encoding comprises i) counting the number of digits of original 3D mesh data and ii) generating a 3D mesh coding (3DMC) packet which includes the encoded 3D mesh data and the number of digits;
transmitting the 3DMC packet to a receiving end; and
decoding the transmitted 3D mesh data of the 3DMC packet at the receiving end so as to reconstruct the encoded original data based on the number of digits.

2. A method of encoding three dimensional (3D) mesh data, comprising:
encoding an original 3D mesh data;
counting the number of digits of the original data; and
generating a 3D mesh coding (3DMC) packet including the encoded original data and the number of digits.

3. A method of decoding three dimensional (3D) mesh data, comprising:
receiving a 3D mesh coding (3DMC) packet, including at least encoded 3D mesh data, from a receiving end;
determining whether the 3DMC packet includes the number of digits of original 3D mesh data;
extracting the number of digits if the number exists; and
decoding the encoded 3D mesh data based on the number of digits.

4. The method as stated in claim 1, wherein the number of digits is included in the header of the 3DMC packet.

5. The method as stated in claim 1, wherein the original 3D mesh data has 8 digits after decimal point.

6. The method as stated in claim 5, wherein the counting is performed up to a maximum of 5, 6, 7 or 8 digits.

7. The method as stated in claim 2, wherein the original 3D mesh data has 8 digits after decimal point.

8. The method as stated in claim 7, wherein the counting is performed up to a maximum of 5, 6, 7 or 8 digits.

9. The method as stated in claim 2, further comprising transmitting the 3DMC packet to a receiving entity for decoding.

10. The method as stated in claim 3, wherein the original 3D mesh data has 8 digits after decimal point.

11. The method as stated in claim 10, wherein the counting is performed up to a maximum of 5, 6, 7 or 8 digits.

12. The method as stated in claim 3, further comprising outputting the decoded 3D mesh data.

13. A device for encoding three dimensional (3D) mesh data, comprising:
an encoder configured to encode an original 3D mesh data;
a counter configured to count the number of digits in the original data; and
a packet generator configured to generate a 3D mesh coding (3DMC) packet including the encoded original data and the number of digits.

14. The device as stated in claim 13, further comprising a transmitter configured to transmit the 3DMC packet to a receiving entity for decoding.

15. The device as stated in claim 13, wherein the original 3D mesh data has 8 digits after decimal point.

16. The device as stated in claim 15, wherein the counter is configured to perform the counting up to a maximum of 5, 6, 7 or 8 digits.

17. A device for decoding three dimensional (3D) mesh data, comprising:
a receiver configured to receive a 3D mesh coding (3DMC) packet, including encoded 3D mesh data and the number of digits of original 3D mesh data, from a receiving entity;
a digit extractor configured to extract the number of digits from the 3DMC packet; and
a decoder configured to decode the encoded 3D mesh data based on the digit number.

18. The device as stated in claim 17, wherein the original 3D mesh data has 8 digits after decimal point.

19. The device as stated in claim 17, wherein the number of digits is included in the header of the 3DMC packet.

20. A device for decoding three dimensional (3D) mesh data, comprising:
means for receiving a 3D mesh coding (3DMC) packet, including at least encoded 3D mesh data, from a receiving end;
means for determining whether the 3DMC packet includes the number of digits of original 3D mesh data;
means for extracting the number of digits if the number exists; and
means for decoding the encoded 3D mesh data based on the number of digits.
